(19) United States
(12) Patent Application Publication
(10) Pub. No.: US 2017/0295754 A1
(43) Pub. Date: Oct. 19, 2017

(54) Animal Collar

(71) Applicant: Jody R. Hiers, Yuma, AZ (US)

(72) Inventor: Jody R. Hiers, Yuma, AZ (US)

(21) Appl. No.: 15/132,526

(22) Filed: Apr. 19, 2016

(51) Int. Cl. A01K 27/00

(52) U.S. Cl. CPC A01K 27/001

(57) ABSTRACT

The present invention is an animal collar (10) that's comprised of an inner flexible bungee (11) that's centrally attached to an inflexible collar (16). An inflexible material (18, 19) is attached to the ends of the flexible bungee (11) and exits the inflexible collar (16) several inches (14, 26) from each end. Rings (22, 23) are attached to the ends of the inflexible material (18, 19) and allows for a leash (31) to be attached. The outer inflexible collar (16) has a buckle (15) and stays static, while the inner bungee (11) ilexes when pressure is applied. A fabric material (17), that is sewn on, covers the inner flexible bungee (11). The collar's (10) ability to flex and stay firmly attached reduces stress on the animal's throat.

### BACKGROUND

### Prior Art

The following is a tabulation of some prior art that presently appears relevant:

### U.S. PATENTS

| Patent Number | Filing Date | Publ. Date | Applicant |
|---|---|---|---|
| 770,070A | 1904 Mar. 12 | 1904 Sep. 13 | Johnson |
| 2,859,732A | 1956 Oct. 25 | 1958 Nov. 11 | Driscoll |
| 3,131,674A | 1963 Apr. 17 | 1964 May 5 | Howard |
| 4,180,016 | 1977 Dec. 19 | 1979 Dec. 25 | George |
| 4,917,049 | 1988 Nov. 7 | 1990 Apr. 17 | Peterson |
| 5,050,538 | 1990 May 11 | 1991 Sep. 24 | Gurski, Jr. |
| 5,865,148 | 1995 Dec. 29 | 1999 Feb. 2 | Aguirre |
| 5,873,328 | 1998 Jan. 21 | 1999 Feb. 23 | Campbell |
| 6,125,793A | 1998 Aug. 10 | 2000 Oct. 3 | Petty |
| 6,990,929 | 2004 Aug. 6 | 2006 Jan. 31 | Wacky Walkr et al. |
| 7,168,394B2 | 2004 Dec. 17 | 2007 Jan. 30 | Berry |
| 7,293,531 | 2005 Dec. 13 | 2007 Nov. 13 | Wacky Walkr et al. |
| 20070245979A1 | 2006 Apr. 21 | 2007 Oct. 25 | Millan |
| 7,296,541B2 | 2006 Jun. 22 | 2007 Nov. 20 | Fredland, Jr. |
| 7,562,640 | 2007 Jul. 17 | 2009 Jul. 21 | Lalor |
| 20120060770A1 | 2010 Sep. 13 | 2012 Mar. 15 | Broock |
| 8,613,262B1 | 2012 Oct. 15 | 2013 Dec. 24 | Mergard |

Animal collars are used to restrain, train, identify and decorate pets. Animals are commonly restrained and trained with chain, prong, leather, nylon, plastic and slip collars around their neck. These types of collars apply stress on the animal's throat, when pressure is applied via a leash. Training collars, like the prong and chain collar, either pinch the animal's skin around the neck or choke the animal around the neck and throat. I have found that these training collars are not aesthetically appealing to pet owners. These types of conventional collars are static and do not flex when pressure is applied via a leash. This pressure can injure or damage the animal's throat. I have found, that, the conventional collars utilize buckles, snaps, or slip-overs that only adjust incrementally and are not fitted for the animal's neck.

Variations on the animal collar are disclosed in order to address these limitations. For example, U.S. Pat. No. 6,125,793A discloses a dog collar having an outside sleeve with a flexible center attached to a male and female end. However, because the male and female end attach to one another, the entire collar stretches and can slip off the dog's neck.

U.S. Pat. No. 7,296,541B2 discloses an animal collar having a flexible strip with two couplers attached. However, the collar is designed to ilex and slip off the animal's neck only when it's not attached to a leash. The collar is static when attached to a leash via the couplers.

### SUMMARY

This animal collar is directed towards overcoming the disadvantages of prior art.

In accordance with one embodiment, the animal collar is comprised of an inner flexible material that is inside an outer collar. The inner flexible material has an inflexible material attached to each end and exits the outer collar via holes. The inflexible material has attachment points on each end so a leash can be attached. The outer collar is static and attaches to itself via a buckle. The outer collar stays connected while the inner flexible material flexes when pressure is applied via a leash. The flexibility of the inner material reduces stress on the animal's throat.

In another embodiment, prongs are attached to the flexible material and provide a correction on the sides of the neck and not on the throat when pressure is applied via a leash.

### ADVANTAGES

An advantage of the present invention is that the internal flexible material reduces stress on the animal's throat, while staying firmly connected, around the animal's neck via the outer collar.

A further advantage of the present invention is that the fabric cover conceals the internal flexible material making it aesthetically pleasing.

A further advantage of another embodiment of the present invention is that the fabric cover conceals the correction prongs thereby acting as a harrier between the prongs and the animal's neck. This makes the collar aesthetically pleasing.

A further advantage of the present invention is that the buckle allows for the collar to be fitted to the animal's neck.

Other advantages of one or more aspects will be apparent from a consideration of the drawings, ensuing description and claims.

### DRAWINGS

### Figures

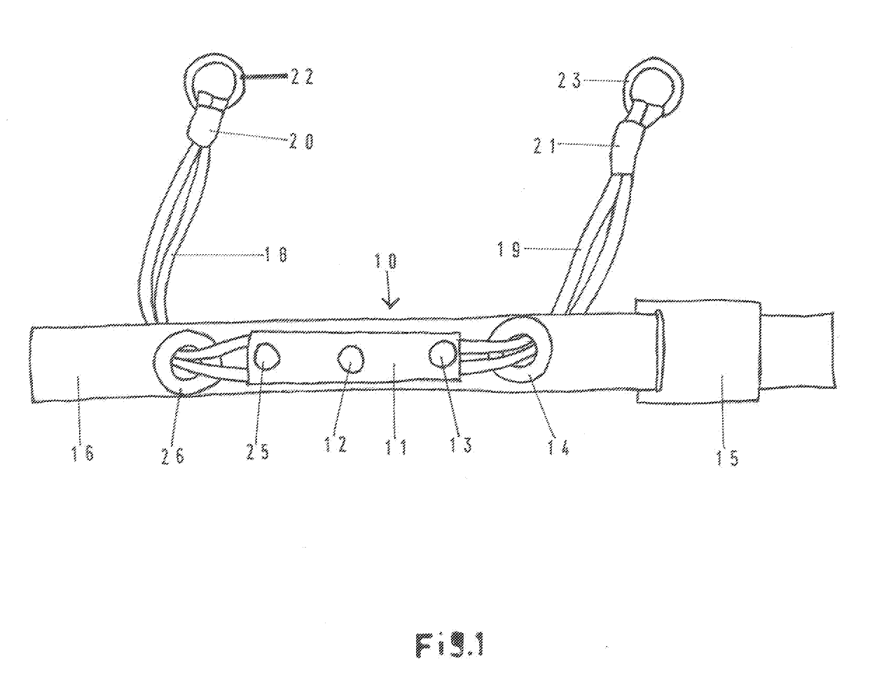

FIG. 1 is a perspective top interior view illustrating an animal collar, without the fabric cover, showing one or more embodiments of the present invention.

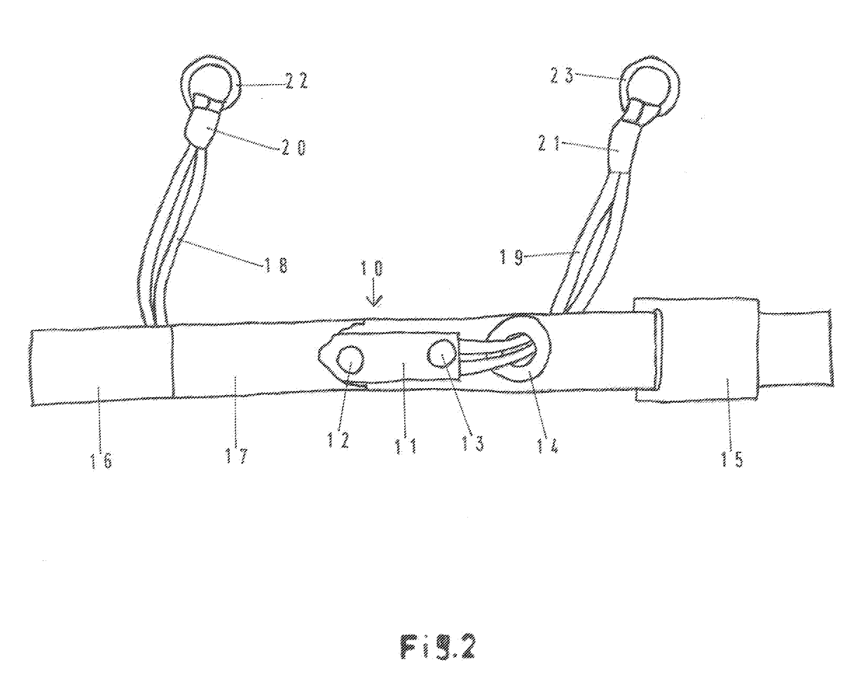

FIG. 2 is a perspective top view illustrating the collar with parts broken away to show certain internal constructions in accordance with one or more embodiments of the present invention.

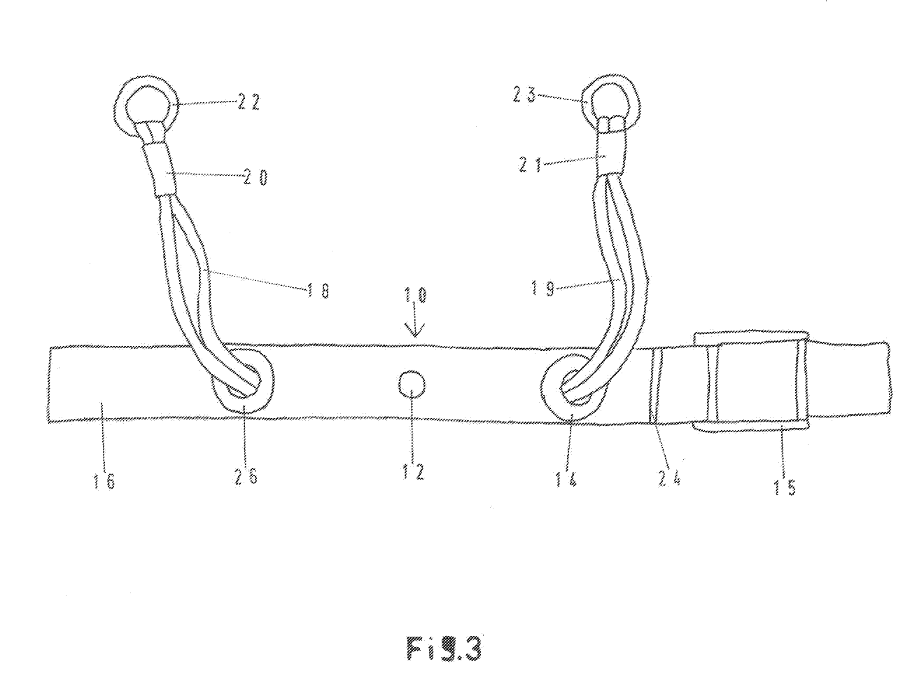

FIG. 3 is a perspective top view illustrating the back of the collar in accordance with one or more embodiments of the present invention.

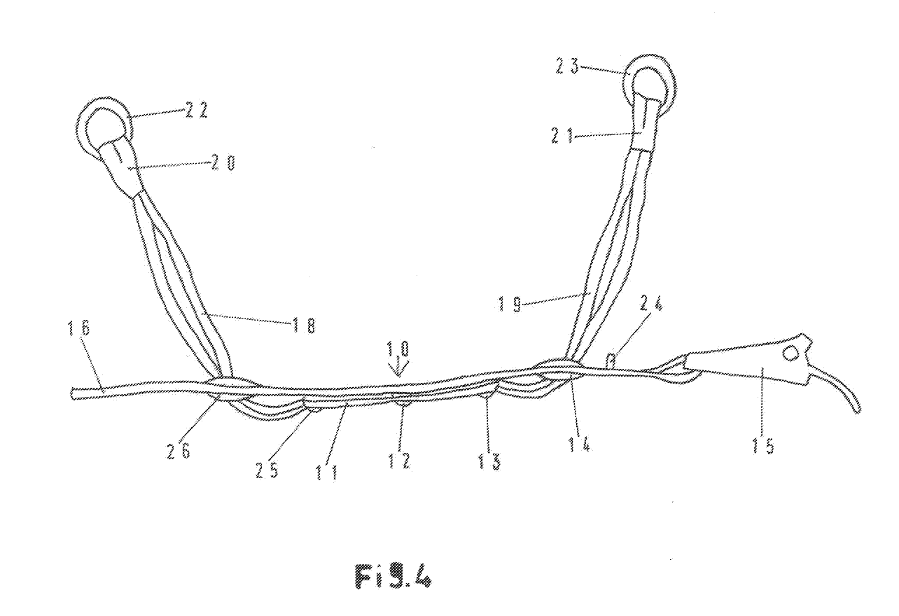

FIG. 4 is a perspective side view illustrating the collar, without the fabric cover, in accordance with one or more embodiments of the present invention.

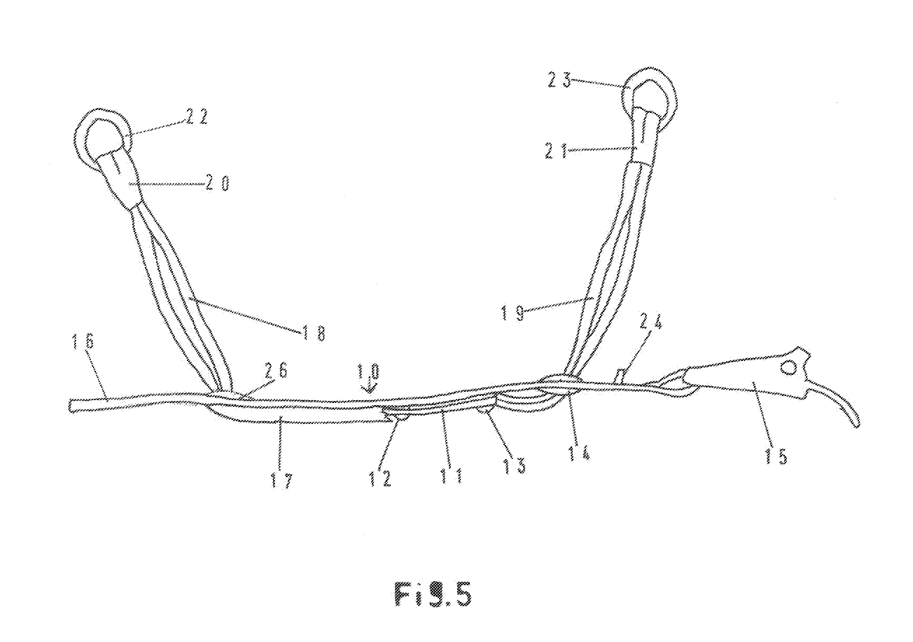

FIG. 5 is a perspective side view illustrating the collar, with parts broken away, to show certain internal constructions in accordance with one or more embodiments of the present invention.

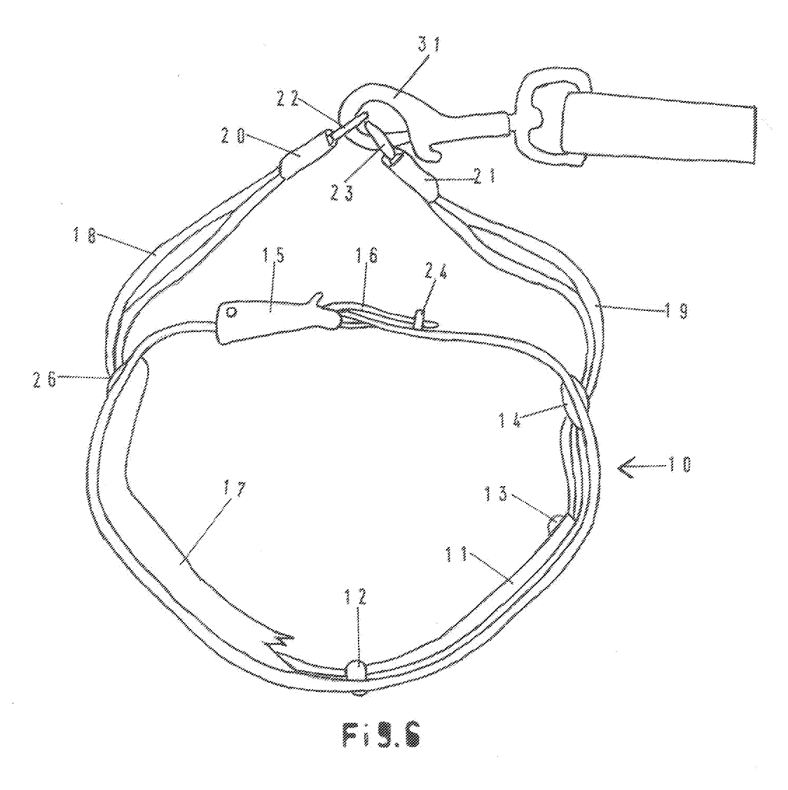

FIG. 6 is a perspective side view illustrating the collar fastened and with a leash attached. The illustration is broken away to show certain internal constructions in accordance with one or more embodiments of the present invention.

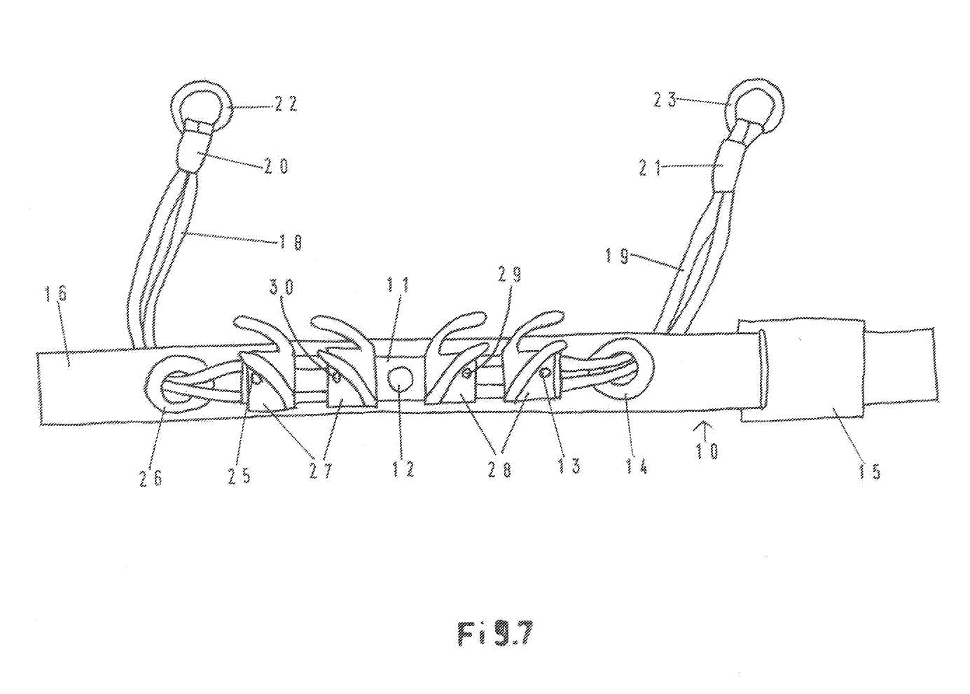

FIG. 7 is a perspective top view illustrating the collar, without the fabric cover, showing one or more embodiments of the present invention.

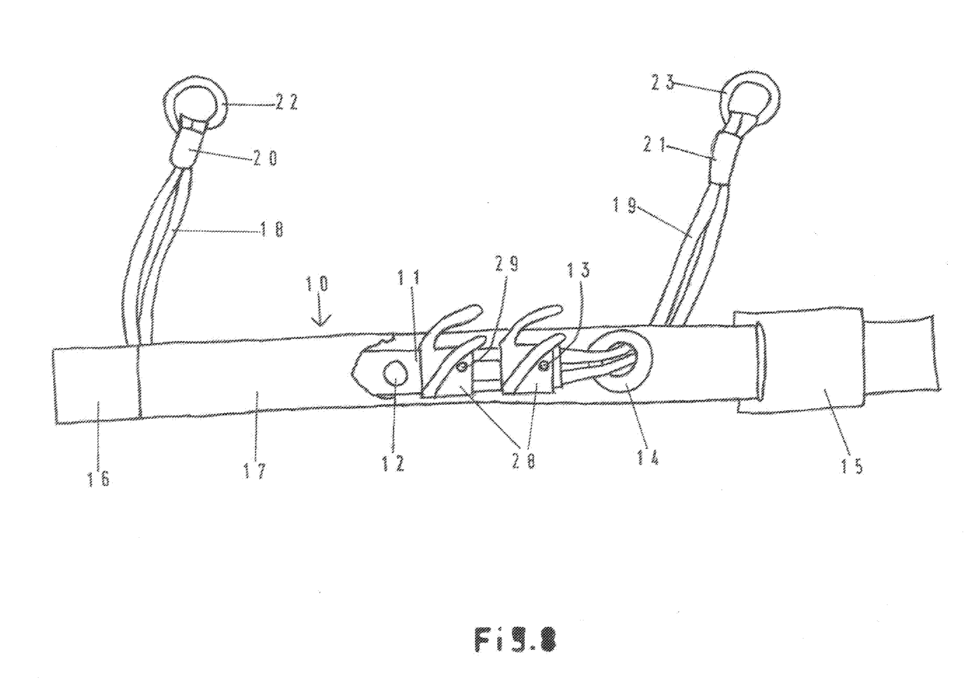

FIG. 8 is a perspective top view illustrating the collar, with parts broken away, to show certain internal constructions in accordance with one or more embodiments of the present invention.

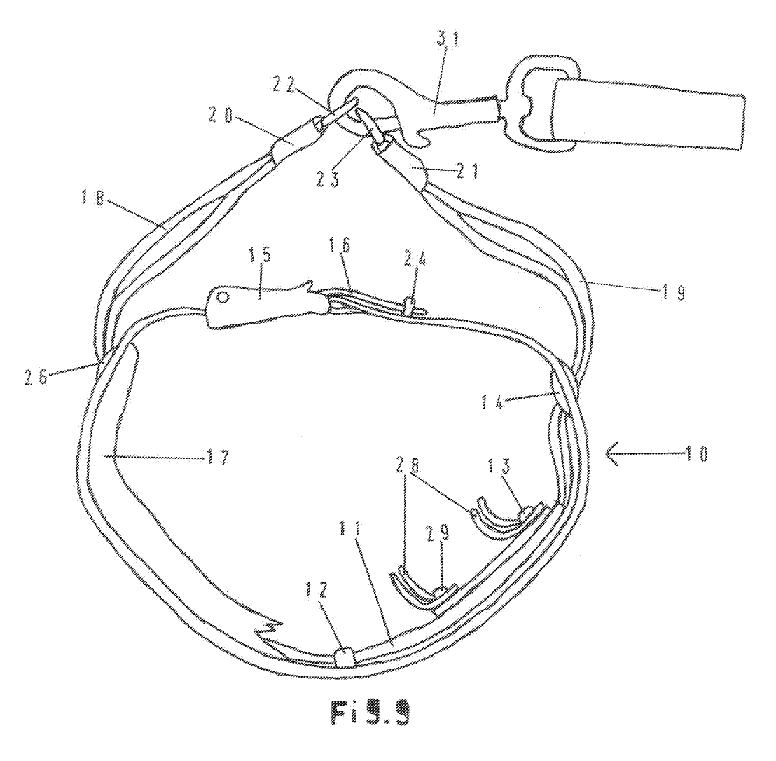

FIG. 9 is a perspective side view illustrating the collar fastened and with a leash attached. The illustration is broken away to show certain internal constructions in accordance with one or more embodiments of the present invention.

FIGS. 1-6 Non-correction

FIGS. 7-9 With correction points

### DETAILED DESCRIPTION

One embodiment of the animal collar 10 is illustrated in FIGS. 1, 2, 3, 4, 5 and 6.

FIG. 1 shows the inside of the collar 10 without the fabric cover 17. The collar 10 in FIG. 1 shows a flat bungee 11 attached to a piece of the nylon 16 with a rivet 12. The rivet 12 goes through the flat bungee 11 and nylon 16 at the center point. One folded piece of 550 cord 18 is attached to the inside of the flat bungee 11 with a rivet 25. The 550 cord 18 exits the nylon 16 through a grommet 26. The other ends of the 550 cord 18 is attached to a metal ring 22 with thread/shrink tubing 20. A second piece of folded 550 cord 19 is attached to the inside of the flat bungee 11 with a rivet 13. The 550 cord 19 exits the nylon 16 through a grommet 14. The other ends of the 550 cord 19 are attached to a metal ring 23 with thread/shrink tubing 21. A cam buckle 15 is attached to one end to the nylon 16 with sewn thread. The collar will have a fabric cover 17, that is sewn on, as illustrated in FIG. 2.

The collar 10 in FIG. 2 is the same perspective view as FIG. 1. The collar in FIG. 2 shows a cut away of the fabric cover 17. The fabric cover 17 will cover the bungee 11 from grommet 26 to grommet 14.

The collar 10 in FIG. 3 is a back view. The back view shows the back of rivet 12 that connects the flat bungee 11 to the nylon 16. The tag tab 24 is sewn on the nylon 16.

The collar 10 in FIG. 4 illustrates a side view perspective without the fabric cover 17.

The collar 10 in FIG. 5 illustrates the same perspective side view as FIG. 4 with the addition of the cut away fabric cover 17.

The collar 10 in FIG. 6 is a perspective side view illustrating the collar 10 fastened with the cam buckle 15. The collar 10 illustrates how the rings 22 and 23 are hooked to a leash 31. The tag tab 24 illustrates where the excess nylon can be placed. The collar 10 shows a cut away of the fabric cover 17.

FIG. 7 illustrates an embodiment of the collar 19 with correction prongs 27 and 28 attached to the flat bungee 11 with rivets 13, 25, 29, and 30. The collar 10 is a top view illustration without the fabric cover 17.

The collar 10 in FIG. 8 is the same view as FIG. 7, with the addition of the cut away fabric cover 17.

The collar 10 in FIG. 9 is the same side view as FIG. 6, with the additional embodiments of the correction prongs 27 and 28. The prongs are attached with rivets 13 and 29, with a cut away view of the fabric cover 17.

### Operation

The manner of using the collar 10 is to connect the cam buckle 15 to the other end of the nylon 16. The two rings 22 and 23 are connected to the leash clasp 31. The collar 10 flexes because of the connection of the rings 22 and 23 to the 550 cord 18 and 19, and the 550 cord 18 and 19 to the flat bungee 11. The cam buckle 15 connection allows the collar 10 to stay attached to the animal's neck when flexing. The embodiment of the collar 10, including the correction prongs 27 and 28, flexes while providing a correction. The internal parts of the collar 10 are covered by a fabric cover 17, which is more aesthetically pleasing. The internal flex, combined with the non-flex outer collar 16, produces less stress on the animal's throat, while continuing to be safely secured.

### Advantages

From the description above, a number of advantages of my animal collar becomes evident:

(a) The flexible inner bungee produces less stress on the animal's neck and throat when pressure is applied.

(b) The outer collar does not flex and stays firmly connected to the animal. This allows the inner collar to flex when pressure is applied and still stay firmly connected.

(c) The outer cover conceals the inner workings of the collar. This allows for the safe function of the collar.

(d) The correction, points flex with the bungee when pressure is applied. This allows for the correction to occur, without overcorrecting the animal.

(e) The correction points are covered with the outer material, therefore, making the collar aesthetically appealing and functional. The outer material also provides a barrier between fix correction points and the animal's skin. This provides another safety property.

(f) The cam buckle allows the collar to he fitted for the animal, it also allows the collar to stay centered over the animal's neck.

### CONCLUSION, RAMIFICATIONS, AND SCOPE

Accordingly, the reader will see that the animal collar, described above, is designed to flex in a manner to reduce stress on the animal's neck. The collar's outer sheath provides a non-flexible anchor point that stays attached to the animal. The correction prong embodiment provides a flexible correction with less stress on the animal's neck. The fabric cover is aesthetically pleasing because it covers the internal, parts. The cam buckle embodiment allows for the collar to be adjusted in a manner that is fitted for the animal's neck.

Although the description above contains many specificities, these should not be construed as limiting the scope of the embodiments but as merely providing illustrations of some of several embodiments. For example, the collar can be made of nylon, leather, plastic, and cloth. The bungee can be flat, round, or made of any flexible material Thin nylon, rope, cord, plastic, cloth, or any inflexible material can be substituted for the 550 cord. The 550 cord openings can be sewn, grommets, or eyelets. The rivets can be substituted with a buckle, snap, or hook fastener; and made of plastic, metal or any hard material. The 550 cord rings can be sewn cord and made of metal, plastic, or any hard material. The correction prongs can be made of metal, plastic, or any hard material The prongs can be single, double, or multiple parts. The fabric cover can be cloth, denim, nylon, leather, or plastic. The fabric cover can be sewn, glued or riveted on.

Thus the scope of the embodiments should be determined by the appended claims and their legal equivalents, rather than by the examples given.

I claim:

1. An animal collar comprising: a flexible material inside an outer sleeve; an inflexible material attached to each ends of said flexible material that exits said exterior sleeve; a connection device attached to said inflexible material ends; a connection device to said outer sleeve ends.

2. The animal collar of claim 1, wherein the said flexible material is a flat bungee cord centrally attached to the inside of said outer sleeve with rivet.

3. The animal collar of claim 1, wherein the said flexible-material is a rubber material centrally attached to inside of said outer sleeve with rivet.

4. The animal collar of claim 1, wherein the said flexible material is an elastic material centrally attached with rivets.

5. The animal collar of claim 1, wherein the said outer sleeve is made of nylon.

6. The animal collar of claim 1, wherein the said outer sleeve is made of leather.

7. The animal collar of claim 1, wherein the said outer sleeve is made of materials consisting of cloth, said nylon, and said leather.

8. The animal collar of claim 1, wherein the said outer sleeve is made of materials consisting of spandura and said nylon.

9. The animal collar of claim 1, wherein the said inflexible material is 550 cord to said flexible material ends with screws.

10. The animal collar of claim 1, wherein the said inflexible material is 550 cord attached to said flexible material ends with rivets.

11. The animal collar of claim 1, wherein the said inflexible material is chain attached with rivets.

12. The animal collar of claim 1, wherein the said inflexible material is chain attached with screws.

13. The animal collar of claim 1, wherein the said inflexible material exits said exterior sleeve through grommet openings.

14. The animal collar of claim 1, wherein the said inflexible material exits said exterior sleeve through sewn openings.

15. The animal collar of claim 1, wherein the said connection device attached to said inflexible material ends are rings.

16. The animal collar of claim 1, wherein the said connection device attached to said outer sleeve ends is a buckle.

17. The animal collar of claim 1, further including prongs attached to the said flexible material with screws.

18. The animal collar of claim 1, wherein the said prongs are attached to the said flexible material with rivets.

19. The animal collar of claim 1, further including a tab attached to said outer sleeve.

20. The animal collar of claim 1, further including shrink tubing to cover said end connections of inflexible material.
